(19) United States
(12) Patent Application Publication
(10) Pub. No.: US 2002/0179880 A1
(43) Pub. Date: Dec. 5, 2002

(54) Engine cooling method and composition

(76) Inventor: David A. Kimmey, Boynton Beach, FL (US)

Correspondence Address: J. Rodman Steele, Jr., Akerman Senterfitt, 222 Lakeview Avenue, Fourth Floor, P.O. Box 3188, West Palm Beach, FL, 33402-3188, US

(21) Appl. No.: 10/125,752

(22) Filed: Apr. 18, 2002

Related U.S. Application Data
(60) Provisional application No. 60/295,171, filed on May 31, 2001.

(51) Int. Cl. C09K 5/00

(52) U.S. Cl. 252/70; 252/71; 252/75

(57) ABSTRACT

A method of preparing an engine antifreeze-coolant includes the steps of providing a base fluid and at least a second fluid. The method includes the steps of premixing the base fluid and the second fluid and packaging the premixed engine antifreeze-coolant. The base fluid includes propylene glycol and the second fluid comprises de-ionized water. A method of administering an engine antifreeze-coolant to an engine of a motor vehicle includes the steps of providing a container having a combination of premixed propylene glycol and de-ionized water, and delivering the engine antifreeze-coolant from the container to the engine. A composition of engine antifreeze-coolant includes from 40 to 60 weight percentage of propylene glycol, from 40 to 60 weight percentage of de-ionized water, and from 0.0 to 3 weight percentage of a coloring agent. A engine antifreeze-coolant container includes a receptacle having a first end and a second end opposite the first end, an opening located on at least one of the first end and the second end of the receptacle, and a closure mechanism having an inner surface and an outer surface.

### CROSS REFERENCE TO RELATED APPLICATIONS

(Not Applicable)

### STATEMENT REGARDING FEDERALLY SPONSORED RESEARCH OR DEVELOPMENT

(Not Applicable)

### BACKGROUND OF INVENTION

1. Technical Field

The present invention relates generally to engine coolants.

2. Description of the Related Art

Several attempts have been made to develop an engine coolant with cooling ability and corrosion prevention in the engines of motor vehicles. For instance, a number of inventions in the prior art have incorporated the use of engine coolants to maintain engine temperature and performance. Specifically, Turcotte et al. in U.S. Pat. No. 6,203,719 discloses an engine coolant that provides corrosion inhibition formulations and compositions for inhibiting mineral scale formation and corrosion of metals, particularly the cavitation corrosion of aluminum in the presence of aqueous liquids. Moreover, the coolant in Turcotte utilizes the combination of a mixture of polymeric polycarboxylates, azoles, nitrate salts, phosphates, stabilized silicates and transition metal compounds. The combination disclosed in Turcotte provides a synergistic protective effect against the cavitation corrosion of aluminum in aqueous liquids to reduce the corrosion rate and is effective in relatively low concentrations. While the coolant in Turcotte can be adequate for the purpose and function for which it is specifically used, the coolant contains many additives that are not suited for all engines and motor vehicle applications. Over a period of time, additives such as silicates, azoles, and nitrates can be consumed and add to the corrosive effect on the engine of a motor vehicle. Consequently, many of the coolants that contain additives can have a deleterious effect on the engine over time unless extreme precautionary measures are taken.

Other engine coolants are available in the prior art, however the vast majority of coolants in the prior art utilize ethylene glycol. Although ethylene-glycol based engine coolants provide adequate cold weather protection and corrosion resistance, these products are hazardous to the environment. For instance, ethylene glycol based products are poisonous to humans, animals and plant life. Additionally, many engine coolants available in the prior art are available only in concentrations having a one hundred percent glycol content. Thus, consumers utilizing these types of products must subsequently prepare the coolant utilizing additional additives. Individually preparing the coolant can become problematic because consumers customarily dilute the engine coolant with faucet water, which adds impurities to the coolant. The prepared coolant also can present a risk when prepared in inadequate concentrations. For instance, a consumer preparing a coolant in inadequate concentrations can cause serious damage to the engine if the concentration is not suited to maintain temperature of the particular engine. In addition to not being diluted in adequate concentrations that promote the efficient operation of one's engine, the impurities present in a coolant diluted with faucet water can further exacerbate corrosion in the engine. Also, there exists an added risk of danger from handling coolants that may contain ethylene glycol, which is hazardous to humans.

Various type of engine coolants are available in the automotive industry that can be utilized to inhibit corrosion in engines and maintain the engines effectiveness. However, many of these products contain additives having chemical and physical characteristics that can nullify the efficiency of the coolant. Engine efficiency has become important for fuel consumption concerns and even more important to owners of high performance automobiles and motorcycles where engine performance is a priority. The various coolants presently available on the market sometimes have too many additives or a coolant that requires the user to guess at preparing suitable concentrations for a particular vehicle. Engine coolants should be simple to use and effective at preventing an engine from overheating or freezing. Accordingly, there exists a need for an engine antifreeze-coolant that is non hazardous, while providing effective and efficient cooling capabilities and corrosion prevention in an engine of a motor vehicle.

### SUMMARY OF INVENTION

The present invention relates to an engine antifreeze-coolant. More particularly, the present invention provides a method of preparing an engine antifreeze-coolant that can be utilized in an engine of a motor vehicle. The present invention provides a method of administering an engine antifreeze-coolant to an engine of a motor vehicle. The invention also provides a composition that can be utilized to provide for the cooling and corrosion prevention in an engine of a motor vehicle. The present invention further provides a container containing the composition that can be utilized for providing an engine antifreeze-coolant to the engine of a motor vehicle

Accordingly, a method of preparing an engine antifreeze-coolant comprises the steps of providing a base fluid and at least a second fluid. The method also comprises the step of premixing the base fluid and the second fluid at a predetermined concentration. The base fluid and the second fluid forming an engine antifreeze-coolant. The method further includes the steps of packaging the premixed engine antifreeze-coolant into a container. The base fluid comprises propylene glycol and the second fluid comprises de-ionized water. The method also can include a coloring agent.

In accordance with the invention, a method of administering an engine antifreeze-coolant to an engine of a motor vehicle comprises the steps of providing a container having a combination of premixed propylene glycol and de-ionized water, and delivering the engine antifreeze-coolant from the container to the engine.

In this invention, a composition of engine antifreeze-coolant comprises from 40 to 60 weight percentage of propylene glycol, from 40 to 60 weight percentage of de-ionized water, and from 0.0 to 3 weight percentage of a coloring agent. The weight percentage is based on the total weight of the composition of engine antifreeze-coolant. A preferable composition of engine antifreeze-coolant can comprise concentration of propylene glycol comprising 50% propylene glycol and 50% de-ionized water by weight of the composition.

In the present invention, a engine antifreeze-coolant container comprises a receptacle having a first end and a second end opposite the first end, an opening located on at least one of the first end and the second end of the receptacle, and a closure mechanism having an inner surface and an outer surface. The engine antifreeze-coolant container is equipped to receive the engine antifreeze-coolant.

The engine antifreeze-coolant of the present invention provides reduced operating temperatures by as much as 50° F. and increased horsepower to the engines of motor vehicles. The invention also provides a toxic free substance that is not harmful to humans or the environment. The present invention allows motor vehicles to remain operable an efficient in extreme weather conditions, while maintaining overall engine temperature and performance.

### BRIEF DESCRIPTION OF THE DRAWINGS

The invention is pointed out with particularity in the appended claims. The above and further advantages of this invention may be better understood by referring to the following description taken in conjunction with the accompanying drawings, it being understood, however, that the invention is not limited to the precise arrangements and instrumentalities shown.

FIG. 1 Shows a perspective view of a container providing the engine antifreeze-coolant enclosed;

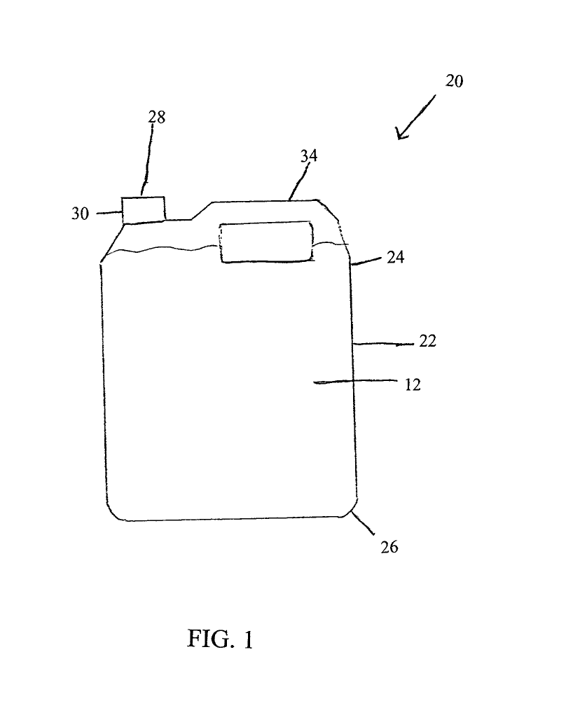

FIG. 2 Shows a perspective view of a container being utilized to administer engine antifreeze-coolant to an engine of a motor vehicle;

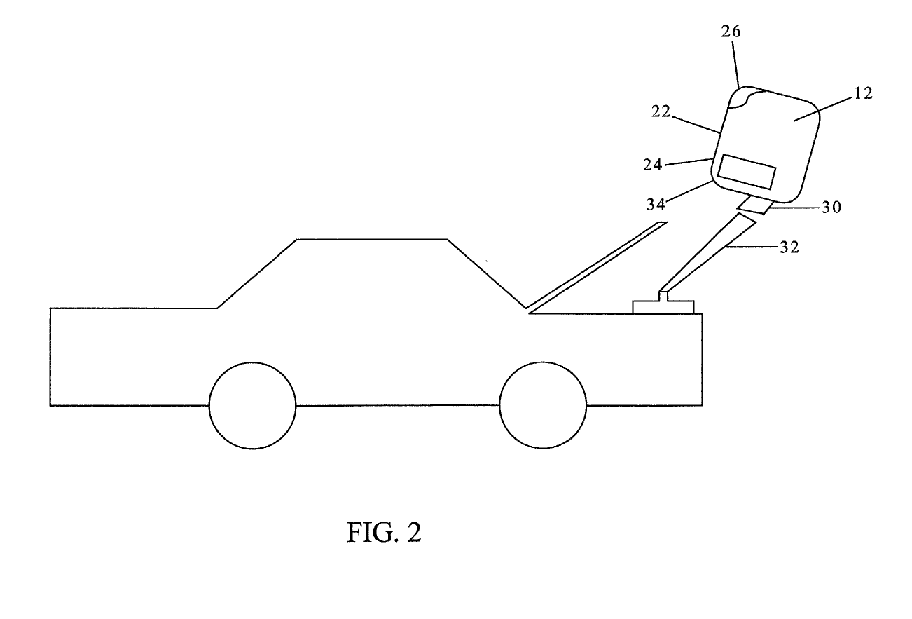

FIG. 3 Shows a flow chart of method of preparing an engine antifreeze-coolant; and

FIG. 4 Shows a flow chart of method of administering an engine antifreeze-coolant.

### DETAILED DESCRIPTION OF PREFERRED EMBODIMENTS

The present invention relates to an engine antifreeze-coolant. More particularly, the present invention provides a method of preparing an engine antifreeze-coolant that can be utilized in an engine of a motor vehicle. Additionally, the present invention provides a method of administering an engine antifreeze-coolant to an engine of a motor vehicle. The invention also provides a composition that can be utilized to provide for the cooling and corrosion prevention in an engine of a motor vehicle. The present invention further provides a container containing the composition that can be utilized for providing an engine antifreeze-coolant to the engine of a motor vehicle. Although the illustrations provided herewith depict the present invention in specific embodiments, it is understood that the invention can exist in several embodiments.

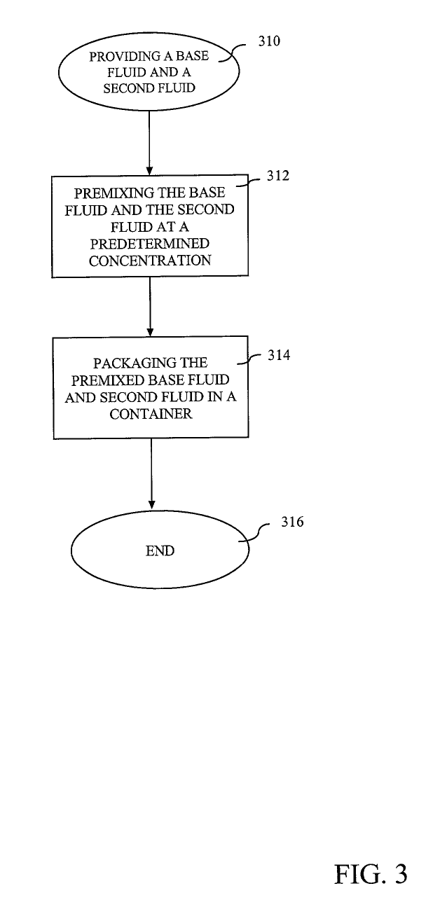

A method of preparing an engine antifreeze-coolant 12 can comprise the step 310 of providing a base fluid 14 and at least a second fluid 16, as illustrated in FIG. 3. According to the invention, the method also comprises the step 312 of premixing the base fluid 14 and the second fluid 16 at a predetermined concentration. The method also can comprise the step of combining a coloring agent 18 to the mixture containing the base fluid 14 and the second fluid 16. The method further comprises the step 314 of packaging the premixed engine antifreeze-coolant 12 into a container 20. In a preferred variation of the premixing, the base fluid 14 is propylene glycol and the second fluid 16 is de-ionized water. The propylene glycol is relatively harmless against plants, animals and the environment.

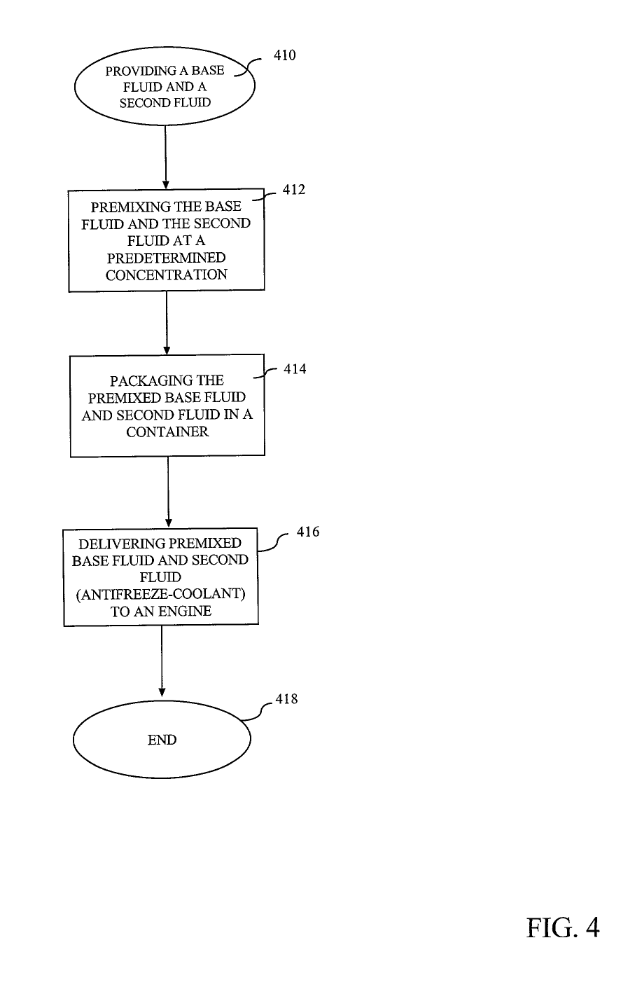

The present invention also provides a method of administering an engine antifreeze-coolant 12 to an engine of a motor vehicle, as shown in FIG. 4. The method of administering an engine antifreeze-coolant 12 to an engine comprises the step of providing a container 20 having a combination of premixed propylene glycol and de-ionized water. According to the invention, the combination of premixed propylene glycol and de-ionized water are prepared by providing a base fluid 14 and at least a second fluid 16 and premixing the base fluid 14 and the second fluid 16 at a predetermined concentration, as illustrated by steps 410 and 412 of FIG. 4. Additionally, the mixture can include the step 414 of packaging the premixed engine antifreeze-coolant 12 into a container 20. Although not necessary, the method can also comprise the steps of removing any pre-existing antifreeze-coolant 12 and disposing of any pre-existing antifreeze-coolant 12 as directed by local, state and federal laws. The method also can comprise the steps of rinsing and flushing the cooling system of the engine. The method also comprises the step of aligning the container 20 with the engine having a radiator to receive the engine antifreeze-coolant 12. Additionally, the method comprises the step 416 of engaging the container 20 to the engine and delivering the engine antifreeze-coolant 12 from the container 20 to the engine. The engine antifreeze-coolant 12 can be added via the radiator or other appropriate mechanism.

The present invention also provides a composition of engine antifreeze-coolant 12 comprising propylene glycol and de-ionized water in a combination that provides the most efficient cooling conditions for an engine of a motor vehicle. The composition can include varying combinations of propylene and de-ionized water. The percentage of propylene glycol by weight of the composition can range from 40 percent to 60 percent. The composition also can include a coloring agent 18. The coloring agent 18 can be included in the composition to provide added aesthetic value. The natural color of the composition having propylene glycol and de-ionized water is clear. The coloring agent 18 utilized in the composition provides aesthetics without changing the physical characteristics of the composition. The most preferable coloring agent 18 included in the composition is blue. For instance, FDNC blue number one containing water, citric acid and sodium benzoate can be utilized as the coloring agent 18. The coloring agent 18 can be included in the composition between 0 to 3 percent by weight of the composition. In most engines the composition of propylene glycol and de-ionized water is mixed at a ratio of fifty percent propylene and fifty percent de-ionized water (i.e. 1 to 1 ratio). The freezing point of the composition having a 1 to 1 ratio of propylene glycol to water is −26° F., which is the temperature of initial ice crystal formation. The boiling point of a composition of engine coolant having a 1 to 1 ratio is 256° F. Additionally, a composition of engine antifreeze-coolant 12 having a 1 to 1 ratio has a pH between 10.5 and 10.8. The increased temperature range between the boiling point and freezing point of the engine antifreeze-combination provides an engine with increased resistance against corrosion.

The composition of the invention offers several advantages over the conventional coolants. The composition of the engine antifreeze-coolant 12 of the present invention provides efficient and effective heat transfer within an engine of a motor vehicle. Additionally the pre-mixed solution decreases risk associated with the handling of dangerous chemicals, such as ethylene glycol. The present invention also provides a pre-mixed solution that is ready for use in an engine of a motor vehicle without having to guess at preparing an adequate concentration of coolant. For instance, the engine antifreeze-coolant 12 having a ratio of fifty percent propylene glycol and fifty percent de-ionized water is advantageous when utilized in a motorcycle engine. The engine antifreeze-coolant 12 of the present invention provides efficient cooling capabilities and corrosion prevention performance. Premixing the propylene glycol with de-ionized water provides a composition for direct use in an engine, and does not require the addition of water to the premixed composition. Premixing de-ionized water in the solution eliminates the harmful minerals and chemicals prevalent in bottled water, distilled water and faucet water. Utilizing the engine antifreeze-coolant 12 provided in the present invention helps to eliminate the scarring, scaling and deposit build-ups found with products incorporating material having components and additives that may be corrosive to an engine of a motor vehicle. The combination of de-ionized water assists the engine in maintaining a constant engine temperature over a prolonged period.

The use of propylene glycol helps to guard against accidental poisoning of humans, pets, plants and wildlife. Propylene glycol is less toxic and thereby safer than ethylene glycol, which is used in most coolants and antifreezes. Due to the low toxicity of propylene glycol, no OSHA upper exposure limits have been set for propylene glycol airborne mist in the workplace. The engine antifreeze-coolant 12 of the present invention does not contain any phosphate materials, which can be detrimental to the environment, specifically trees and plant life.

Additionally, the engine antifreeze-coolant 12 provided in the present invention passes performance test established by government, manufacturer and standard industry tests required for antifreeze-coolant 12 solutions. The engine antifreeze-coolant 12 of the present invention meets the requirements of ASTM D5216 (Propylene Glycol Base Engine Coolant), the corrosion prevention requirements of ASTM D 3306, ASTM D 4985, GM 1899, GM 1825 including ASTM D 1384 (Glassware Corrosion), ASTM D 2570 (Simulated Service), ASTM D 2809 (Cavitations Erosion-Aluminum Pumps), and ASTM D 4340 (Hot Surface-Aluminum Corrosion). In addition the engine antifreeze-coolant 12 provided by the present invention provides protection against boil-over and freezing damage due to the increased temperature range.

The engine antifreeze-coolant 12 can be utilized in a variety of weather conditions. The engine antifreeze-coolant 12 of the present invention is beneficial in extreme heat and humid conditions such as those prevalent in areas such as South Florida. For instance, the engine antifreeze-coolant 12 can reduce operating race temperatures by as much as 50° F. In the area of motor cycle racing the use of the engine antifreeze-coolant 12 has been utilized to reduce engine operating race temperatures, which correspondingly results in increased overall engine performance. The engine antifreeze-coolant 12 also provides the benefit of reducing pump gasket and seal failures within engines. The engine antifreeze-coolant 12 can be utilized to provide for the effective cooling of engines having high load and high stress conditions. For example, the engine antifreeze-coolant 12 can be utilized in snowcross and snowmobiles to reduce engine temperature. The engine antifreeze-coolant 12 can provide protection in temperatures up to −54° F. without any difficulty. Additionally, engine antifreeze-coolant 12 can be effective to prevent corrosion and reducing temperatures in smaller engines, such as the engines in motorcycles or hi-performance vehicles. Using the engine antifreeze-coolant 12 allows lower temperatures to be maintained in engines, thereby providing the engine with the ability to extend the duration of its maximum horsepower.

The present invention can include a container 20. The container 20 having a receptacle 22 equipped to receive the engine antifreeze-coolant 12. The receptacle 22 can include a first end 24 and a second end 26. The receptacle 22 can include an opening 28 on at least one of the first end 24 and the second end 26 of the receptacle 22. In one embodiment, the opening 28 can be included on the first end 24 of the receptacle 22. The opening 28 can be utilized to dispense the engine antifreeze-coolant 12 from the receptacle 22 to an engine of a motor vehicle. The receptacle 22 can also include a handle member 34 adapted to at least one of said first end and said second end of said receptacle. The handle member 34 can be utilized to maneuver the receptacle 22 to properly transfer the engine antifreeze-coolant 12 to an engine of a vehicle. The handle member 34 also can be utilized to transport and carry the receptacle 22 during periods of non use.

The container 20 can include a closure mechanism 30, such as a cap, to close the opening 28. The closure mechanism 30 having an inner surface and an outer surface. The closure mechanism 30 can be attached to the opening 28. The closure mechanism 30 can be detachably coupled to the opening 28. The closure mechanism 30 can securely store the engine antifreeze-coolant 12 in the container 20. The closure mechanism 30 can further provide an enclosure to the engine-antifreeze-coolant 12 during periods of non use. The closure mechanism 30 can firmly encloses the engine antifreeze-coolant 12 to prevent particles in the air or debris from contaminating the engine antifreeze-coolant 12. The cap can be coupled to the opening 28 using a coupling mechanism, such as a snap or screw. For example, the inner surface of a closure mechanism 30, such as a cap, can provide threads that can be received along an edge of an opening 28 having corresponding threads, similar to screwing a lid on a jar.

The engine antifreeze-coolant 12 can be received by the engine. The opening 28 of the container 20 can be suited to promote the dispensing and transferring of the engine antifreeze-coolant 12 to an engine of a motor vehicle. The container 20 can include a funnel device 32 adapted to the receptacle 22. The funnel device 32 can be adapted to the opening 28 of the container 20 or engaged on any suitable surface of the receptacle 22. The funnel device 32 can be utilized to facilitate the dispensing of the engine antifreeze-coolant 12 to the engine of the motor vehicle. The funnel can be detachably coupled or permanent attached to the receptacle 22. The container 20 also can have a funnel device 32 combined in the design of the container 20. For instance, in an embodiment featuring a permanently attached funnel device 32 the funnel device 32 can be molded during the original design of the container 20. Additionally, the design of the container 20 can exist in unlimited dimensions, dependent on the size of the container 20 and the intended use of the container 20. In one embodiment of the present invention the design of the container 20 can be provided in a transparent material. A container 20 composed of a transparent material provides a consumer with the ability to visualize the purity of the engine antifreeze-coolant 12. Additionally, the engine antifreeze-coolant 12 can include a coloring agent 18, such as blue, which in conjunction with the clear cover, provides added aesthetic value to the present invention. The container 20 can be composed of any suitable material including wood, plastic, metal and rubber. Preferably, the container 20 is composed of plastic.

It will be understood that the invention is not limited to the specific details described herein, which are given by way of example only, and that various modifications and alterations are possible within the scope of the invention as defined therein. Those skilled in the art may make modifications that include variations in size, materials, shape, form, function and manner of operation, without departing from the principles and concepts set forth herein.

What is claimed is:

1. A method of preparing an engine antifreeze-coolant comprising the steps of:
providing a base fluid and at least a second fluid; and
premixing said base fluid and said second fluid at a predetermined concentration, said base fluid and said second fluid being an engine antifreeze-coolant; and
packaging the premixed engine antifreeze-coolant into a container.

2. The method according to claim 1, wherein said base fluid comprises propylene glycol.

3. The method according to claim 1, wherein said second fluid comprises de-ionized water.

4. The method according to claim 1, wherein said engine antifreeze-coolant includes a coloring agent.

5. The method according to claim 4, wherein said coloring agent is blue.

6. A method of administering an engine antifreeze-coolant to an engine of a motor vehicle comprising the steps of:
providing a base fluid and at least a second fluid; and
premixing said base fluid and said second fluid at a predetermined concentration, said base fluid and said second fluid being an engine antifreeze-coolant;
packaging the premixed engine antifreeze-coolant into a container; and
delivering said engine antifreeze-coolant from said container to an engine.

7. The method according to claim 6, wherein said delivering step further provides removing existing antifreeze-coolant from said engine.

8. The method according to claim 6, wherein said antifreeze-coolant provides a reduction in engine temperature in the range of 0.1 to 50° F.

9. The method according to claim 6, wherein said delivering step further provides disposing of existing antifreeze-coolant as directed by local, state, and federal laws.

10. A composition of engine antifreeze-coolant comprising:
from 40 to 60 weight percentage of propylene glycol;
from 40 to 60 weight percentage of de-ionized water;
from 0.0 to 3 weight percentage of a coloring agent; and
wherein the weight percentage is based on the total weight of the composition of engine antifreeze-coolant.

11. The composition of claim 10, where said concentration of propylene glycol comprises 50 weight percentage propylene glycol and 50 weight percentage de-ionized water by weight of said composition.

12. The composition of claim 10, wherein said coloring agent is blue.

13. An engine antifreeze-coolant container comprising:
a receptacle having a first end and a second end opposite said first end,
an opening located on at least one of said first end and said second end of said receptacle;
a closure mechanism having an inner surface and an outer surface.

14. The engine antifreeze-coolant container of claim 13, wherein said receptacle is equipped to receive said engine antifreeze-coolant.

15. The engine antifreeze-coolant container of claim 13, wherein a label is affixed to said receptacle, said label providing further instructions to said engine antifreeze-coolant.

16. The engine antifreeze-coolant container of claim 13, wherein said closure means includes a safety mechanism, said safety mechanism securing said engine antifreeze-coolant in said receptacle.

17. The engine antifreeze-coolant container of claim 13, wherein said opening of said receptacle is detachably connected to a funnel device.

18. The engine antifreeze-coolant container of claim 13, wherein said opening of said receptacle is adaptable to an engine component.

19. The engine antifreeze-coolant container of claim 18, wherein said engine component is a radiator.

20. The engine antifreeze-coolant container of claim 13, wherein said receptacle comprises at least one material selected from the group consisting of a transparent material, a translucent material and an opaque material.

21. The engine antifreeze-coolant container of claim 13, wherein said receptacle comprises at least a plastic material.

22. The engine antifreeze-coolant container of claim 13, wherein a handle member is adapted to at least one of said first end and said second end of said receptacle.
